(19) United States
(12) Patent Application Publication
(10) Pub. No.: US 2004/0193867 A1
(43) Pub. Date: Sep. 30, 2004

(54) Configurabel network boot management for hetergenous boot options

(76) Inventors: Vincent J. Zimmer, Federal Way, WA (US); Michael A. Rothman, Gig Harbor, WA (US)

Correspondence Address: Anthony H. Azure, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/404,255

(22) Filed: Mar. 31, 2003

(51) Int. Cl. G06F 9/00

(52) U.S. Cl. 713/2

(57) ABSTRACT

A method and system for acquiring boot options from a plurality of servers on a network and selectively booting from one of the boot options. A client issues a boot option request to servers on a network. The client receives boot option offers from a plurality of servers where a boot option offer identifies the boot options available from a particular server. A boot option is selected at the client. The bootable image corresponding to the selected boot option is retrieved by the client via the server.

### FIELD OF THE INVENTION

The field of invention relates generally to computer systems and, more specifically but not exclusively relates to an operating system boot management scheme in a network environment.

### BACKGROUND INFORMATION

Under typical computer system architectures, computers are initialized in a multiphase manner. At a high level these phases include two primary initialization processes: system (i.e., hardware) initialization (“system boot”) and operating system (OS) load and initialization (“OS boot”). During system boot, which is also commonly referred to as “pre-boot” (meaning it is the phase preceding the OS boot), the computer system is self-tested and initialized through loading and execution of system firmware. Under personal computer (PC) architectures, this firmware is commonly referred to as the system's BIOS (basic input/output system). The BIOS is generally defined as the firmware that runs between the processor reset and the first instruction of the operating system loader. This corresponds to the startup operations performed during a cold boot or in response to a system reset. At the start of a cold boot, very little of the system beyond the processor and firmware is actually initialized. It is up to the code in the firmware to initialize the system to the point that an operating system loaded off of media, such as a hard disk, can take over.

The Operating System (OS) boot comprises the portion of a computer system initialization that immediately follows the system boot. PC's load their OS from a boot device, which typically comprises a hard disk drive or a CD-ROM drive. Most PC's provide setup options that enable the user to select a boot device order. For example, the user may set up a PC so as to first look at the system's CD-ROM drive to see if an operating system is present, and if not, look to the next boot device in the list, which will typically be a hard drive. In earlier PC's it was common for the first boot device to be the floppy drive. In instances in which an OS stored on a hard disk has become corrupted to the point that it cannot load, it is necessary to boot from another boot device.

The term “device” in boot device refers to a logical device, which may comprise a physical device, such as a hard disk, CD-ROM drive, etc., or may comprise a “pseudo” drive. For example, a system can be configured to look for a boot device via a computer network. In this case, the boot device is logically mapped to a network server (via the server's network ID). The server will typically provide access to one or more operating system images that may be loaded by clients connected to the server over the computer network. Typically, the OS options provided to a given client will depend on predetermined access right information specified for that client by a system administrator.

In order to access a server for OS load, the client needs to configure itself for network access and locate the server. This is often enabled, in part, via the Dynamic Host Configuration Protocol (DHCP), which provides a mechanism that allows a client to obtain computer network information. During the latter portion of the pre-boot, the client initializes its network interface and broadcasts a DHCP request over the network to which it connects. One or more servers will respond with a reply. The reply will include a dynamic network address assignment for the computer to allow the server and the client to communicate (e.g., an Internet Protocol (IP) address). The computer can then receive information pertaining to the boot options available on the server.

In a typical DHCP scheme, a first-found/first-used policy is established so that the first reply received by the client is the reply accepted by the client. In such a policy, the client will be limited to the boot options available on the server whose reply was received first. Neither computer nor the computer's user can choose boot options that may be available on other servers on the network. Also, maintaining a complete set of boot options on every server in a network wastes storage space and creates a burden on the system administrator.

### BRIEF DESCRIPTION OF THE DRAWINGS

The present invention is illustrated by way of example and not limitation in the accompanying figures.

FIG. 1 is a schematic diagram of a computer network that enables clients to selectively boot from various boot options hosted by a plurality of servers according to one embodiment of the present invention;

FIG. 2 is a flowchart illustrating the logic and operations performed by one embodiment of the invention to selectively boot a bootable image from among a plurality of boot options offered by the plurality of servers;

FIG. 3 is a flowchart illustrating the logic and operations performed by one embodiment of the invention to acquire boot option offers from a plurality of servers; and

FIG. 4 is a schematic diagram illustrating an exemplary computer system that may be used to practice an embodiment of the present invention.

### DETAILED DESCRIPTION

Embodiments of method for configuring a computer on boot in a network environment and computer apparatus for implementing the method are described herein. In the following description, numerous specific details are set forth, such as embodiments pertaining to the EFI framework, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

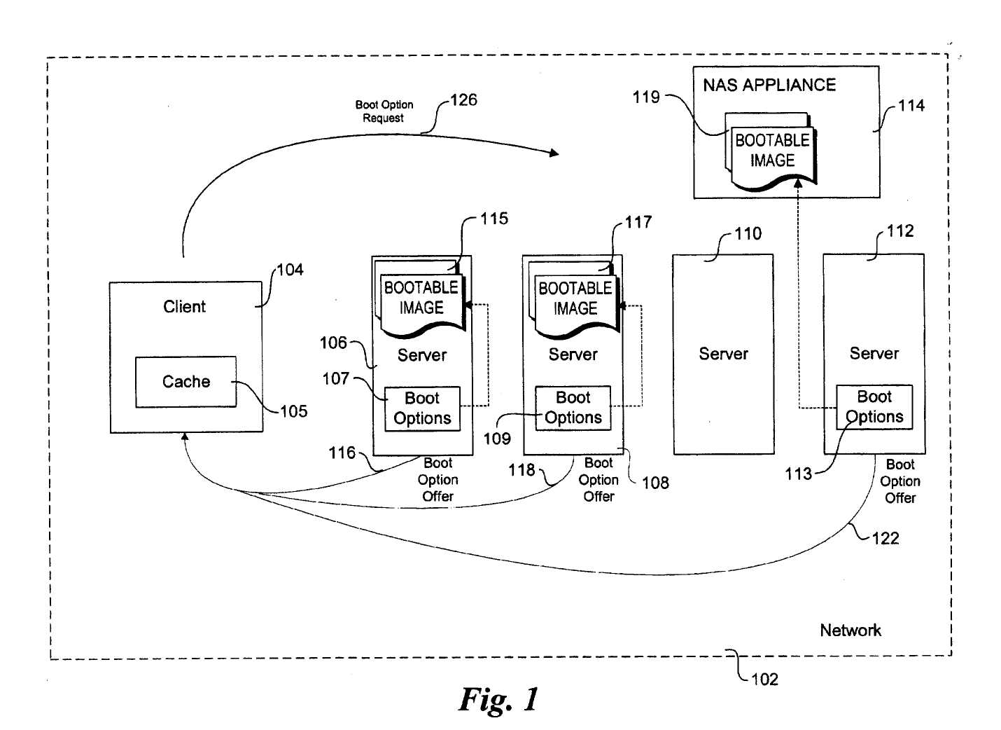

With reference to FIG. 1, a network 102 that enables clients to selectively load operating system images from multiple network resources in accordance with one embodiment of the invention is shown. The network 102 includes a client 104, servers 106, 108, 110, and 112, and a network attached storage (NAS) appliance 114.

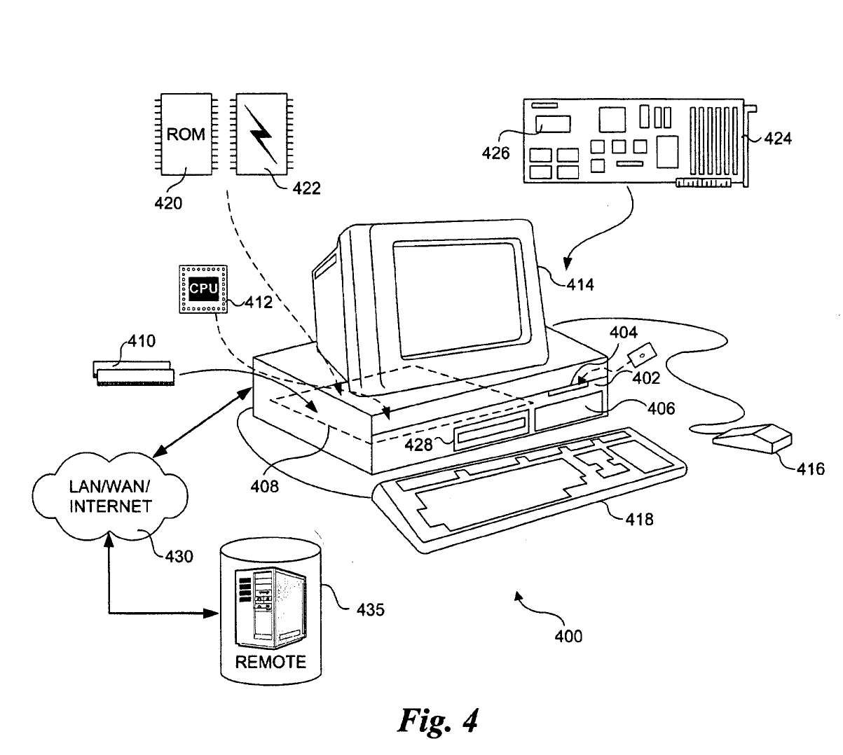

Generally, client 104 may comprise, but is not limited to, a personal computer, a network workstation, a portable computer, a handheld or palmtop computer, a personal digital assistant (PDA), a wireless phone, and the like. In one embodiment, client 104 is configured in a similar manner to an exemplary computer system discussed below in conjunction with FIG. 4.

The client 104 includes a cache 105. Cache 105 may typically comprise a volatile memory such as an L1 cache, static random access memory (SRAM), dynamic random access memory (DRAM), and the like. In another embodiment, cache 105 comprises a storage device such as a magnetic hard disk, an optical disk, and the like.

In general, servers 106, 108, 110, and 112 may comprise conventional computer servers that are well-known in the art. In one embodiment, servers 106, 108 and 112 are designated boot servers on network 102, such as PreBoot Execution Environment (PXE) servers in an EFI (Extensible Firmware Interface) server environment.

For clarity, network 102 is depicted to include a single client and a plurality of servers. However, network 102 will typically connect multiple clients to multiple servers. Furthermore, network 102 may interconnect with other networks and contain sub-networks (both not shown). Network 102 may comprise a Local Area Network (LAN), a Wide Area Network (WAN), or a collection of LANs and WANs, such as an enterprise intranet or the Internet. Typical uses for network 102 include corporate networks, home networks, and public use networks, such as a kiosk at an airport. The connection between client 104 and servers 106, 108, 110, and 112 may comprise a wired connection (e.g., Ethernet, token ring, etc.), a wireless connection including optical systems, satellite transmissions, and the like, or any combination thereof.

In the illustrated embodiment of FIG. 1, each of servers 106, 108 and 112 host boot options 107, 109 and 113, respectively. Each of servers 106 and 108 host one or more bootable images 115 and 117, respectively. Bootable images 119 are stored on NAS appliance 114.

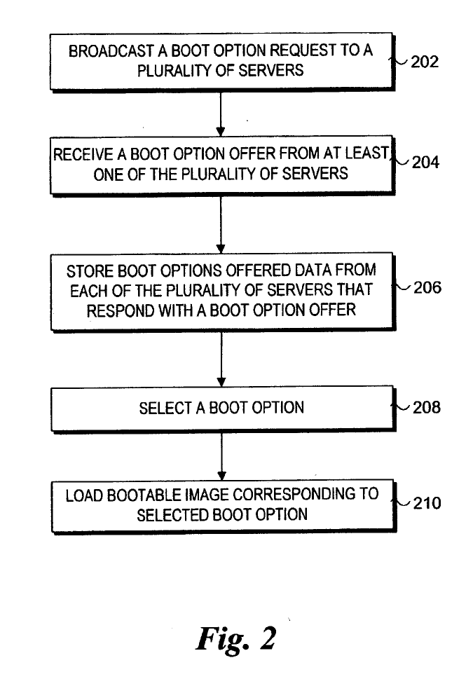

With further reference to the flowchart of FIG. 2, one embodiment of network 102 operates in the following manner to enable clients to selectively boot from multiple bootable images stored across the network 102. The process begins in a block 202, wherein a client broadcasts a boot option request to a plurality of servers coupled to the network 102. For example, in FIG. 1, client 104 issues a boot option request 126 onto the network 102. A boot option request is a request to servers on network 102 to return data identifying any boot options hosted by those servers. In one embodiment, the boot option request 126 also includes a request for a client network address, as described below in further detail. In one embodiment, the client 104 does not need to know the number of or addresses of servers on the network 102, but rather sends a broadcast message containing a boot option request across the network 102, or a subnet of network 102.

Information pertaining to network-bootable images, such as but not limited to operating systems, are stored on various network resources across a computer network. In one embodiment, this information includes boot options and bootable images. A boot option contains data corresponding to one or more bootable images. Clients coupled to the network may load a bootable image via the server that hosts the boot option. Each bootable image contains an executable that is used to load a boot image for the client, such as an operating system.

As discussed above, a boot option includes information identifying which bootable images (e.g., operating systems) may be booted via a respective server. In cases in which a bootable image comprises an operating system, an OS image corresponding to the operation system may be loaded by transferring a copy of a bootable image corresponding to that operating system and configured to be compatible with the requesting client. For example, consider an enterprise environment in which three platform configurations are supported, A, B, and C. Each of platforms A, B, and C having different configurations, requiring different drivers to be loaded. On the other hand, an OS image contains a pre-compiled set of OS executables, drivers, and data particular to a given platform configuration. Thus, in order to support each of platforms A, B, and C, respective OS images should be available for each OS boot option. Example operating system boot options include, but are not limited to, Microsoft Windows 9X, 2000, NT, ME, XP, etc., Apple Macintosh OS, Linux, Unix, Microsoft Windows CE, 3Com Palm OS, and the like.

As used herein, a boot option identifies a particular bootable image selected for execution by the client. Under the foregoing example, these software components comprise operating systems. However, this is not meant to be limiting, as any of various different types of boot options may be accessed for execution. In a corporate network environment, for example, boot options may correspond to OS images with particular security measures, an OS configured for a particular company department, or a beta version of an OS. In a home network environment, exemplary boot options might include a Linux boot, a game-loader Windows boot, and a boot for loading manufacturer specific diagnostics in case of a runtime machine failure.

In one embodiment, bootable image loaders are used to load corresponding bootable images. As discussed below, client 104 will store boot options received from each responding server. When a boot option is selected, the client will use a corresponding bootable image loader to find the server (or another type of network storage device, such as NAS appliance 114) on network 102 that stores the bootable image corresponding to that boot option.

Returning to the flowchart of FIG. 2, in a block 204, the client 104 receives a boot option offer from at least one of the plurality of servers. In FIG. 1, servers 106, 108, and 112 have responded with boot option offers 116, 118 and 122, respectively. A boot option offer indicates to a requesting client that one or more boot options are available via a server for that particular client. A boot option offer includes identifying data regarding the boot options offered. In one embodiment, the boot option offer is a single message from the server to the client that includes the boot options offered from that server. In another embodiment, the boot option offer includes a series of transmissions between the client and the server using DHCP (discussed below) so that the client can obtain the boot options offered.

Note that in FIG. 1, server 110 does not respond with a boot option offer. Server 110 may be out of service, may not contain any boot options, or may not have boot options available to client 104 because of network policy (e.g., security requirements of client 104 and/or its user). Also, a server responding with a boot option offer may not make all its boot options available to a particular client because of compatibility problems with client 104 or network policy concerning certain of its boot options.

In one embodiment, the boot option offers 116, 118 and 122 each include a client network address assigned by the server sending the boot option offer. A client network address enables the client 104 to communicate with each of the servers 116, 118 and 122 to further facilitate retrieval of their respective bootable images. In one embodiment, each server 116, 118 and 122 has its own pool of client network addresses that are available for allocation. In this case, when the client 104 communicates with each server 116, 118 and 122, the client is assigned a new network address from the pool of each respective server. In another embodiment, the servers 116, 118 and 122 share a pool of client network addresses that are available for allocation. In this instance, when one server assigns a client network address to the client, the other servers are made aware of the assignment and may communicate with the client 104 using the same client network address.

In a block 206, the client 104 stores data identifying the boot options offered by each of the servers 106, 108 and 112 that responded to client 104 with a boot option offer. In one embodiment, to store the data, the client 104 completes a handshake with the respective server. The client 104 will successively receive the boot option offers from each server 106, 108, and 112, adding newly received boot option offers to a boot option aggregation (e.g., a list of boot options). In one embodiment, the boot option offers (and their corresponding boot options offered data) received by the client are stored in cache 105, along with the aggregation.

In one embodiment, client 104 will repeatedly broadcast the boot option request 126 across the network 102. In this case, client 104 completes a handshake with a responding server and stores its boot option offer. The client then re-broadcasts the boot option request 126. The client 104 completes a handshake with a second responding server to store its respective boot option offer. The client 104 repeats this process until it obtains the boot option offers available to the client 104 from all responding servers on network 102. As the client 104 stores boot option offers from responding servers, it tracks the servers it has received boot option offers from. In this way, the client 104 determines if it needs to keep re-broadcasting the boot option request 126 and which servers it still needs to complete a handshake with to obtain the servers' boot option offers. In this embodiment, if the servers each have their own pool of client network addresses, the responding servers will each assign a client network address to the client so that the client may complete a handshake to obtain a boot option offer. This will not severely impact the servers because the client network addresses assigned by the servers have a lease that will expire after a predetermined time period. Once a lease expires, a server can re-assign the network address to other resources as necessary.

In block a 208, a boot option is selected. In one embodiment, a selectable list of boot options, based on an aggregation of the boot option offers received by the client, is presented to a user. In one embodiment, duplicate boot options are removed from the boot options presented to the user. In this way, for example, the user will not be presented with multiple boot options corresponding to the same OS. In another embodiment, the client automatically selects a boot option from the aggregation. In this instance, the client is programmed (via setup configuration information or the like) to select a boot option based on a prioritized list stored in the setup configuration information. For example, if three OS boot options are returned, the client will attempt to boot from the OS bootable image having the highest priority among the returned boot options.

Once a boot option has been selected, the client 104 loads the boot option's corresponding bootable image via the server that provided the boot option offer corresponding to that boot option, as depicted by a block 210.

In one embodiment, the network address assigned to the client by the server having the selected boot option may have expired since the client acquired the server's boot options in block 206. The client can re-establish contact with the server having the selected boot option. The client can complete the handshake again with the server having the selected boot option to obtain a new network address from that server.

The method of FIG. 2 offers numerous advantages. By not implementing a first-found/first-used policy, every server in a system is not required to contain every boot configuration. This saves the time and expense of maintaining homogeneous boot options across all servers in a network. From a user's perspective, there is no loss in network consistency because the user continues to be presented with a complete set of boot options even though each server does not have every boot option. Also, there is no change required on the server side of a network, because the solution is within the scope of the requester (e.g., client 104). Additionally, the deployment of a network can be accelerated because a server with new boot options can simply be added to the network without having to update the boot options of the other servers on the network.

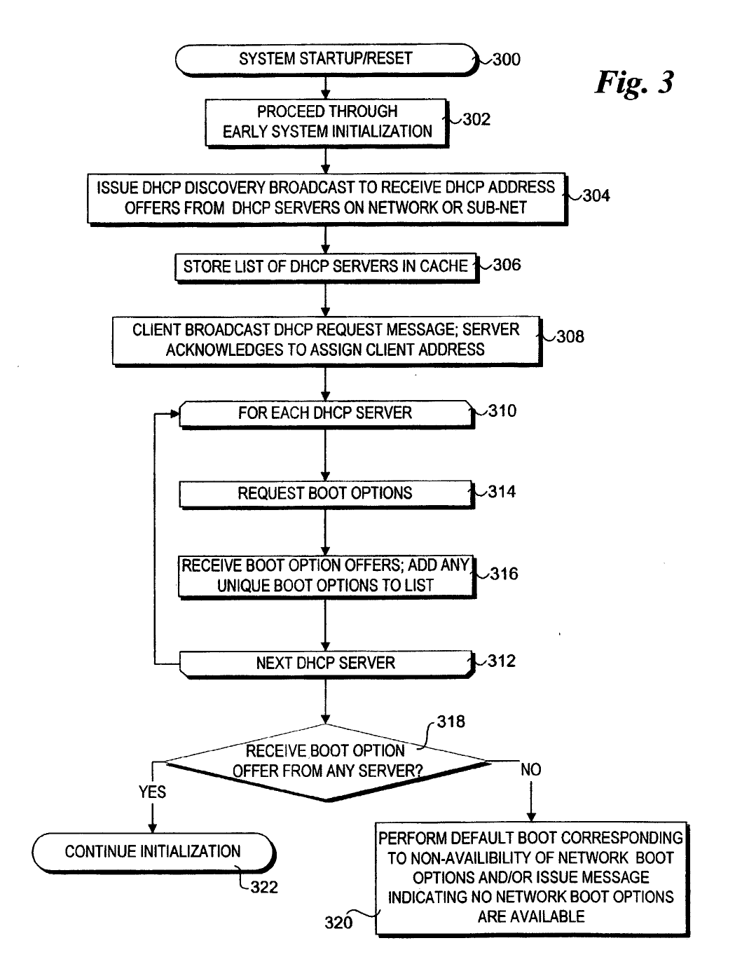

Another flowchart illustrating further details of logic and operations performed in accordance with an embodiment of the present invention is shown in FIG. 3. The process begins in a start block 300, which corresponds to a system startup event, i.e., a cold boot or a system reset.

In response to the startup event, onboard initialization of the client will begin through loading and execution of system boot instructions stored in the client's BIOS, as depicted by a block 302. In one embodiment, the system boot instructions will begin initializing the client by conducting a Power-On Self-Test (POST), initializing system board functions, checking for any expansion boards that hold additional BIOS code, and loading such BIOS code if any is found. This system initialization phase includes initializing the client's network interface to enable the client to access various network resources on the network to which it is connected prior to loading an operating system.

In one embodiment, the client's BIOS includes instructions and data compliant with the EFI framework. Under the EFI 2.0 architecture, the initialization process includes various execution phases of firmware stored on the client. These execution phases include a Pre-EFI Initialization (PEI) phase, a Driver eXecution Environment (DXE) phase, and an EFI 1.0 execution phase. These phases enable initialization and set-up of various platform devices and services, and enable an operating system to be booted in accordance with an OS launch phase that follows the EFI 1.0 execution phase. In this instance, initialization of the client's network interface is performed during the DXE phase.

After the network interface has been initialized, in a block 304 the client broadcasts a DHCP discovery message to receive DHCP address offers from any listening DHCP servers on the network or sub-net. In accordance with the DHCP framework, a client initially is not assigned to a network address, but rather is dynamically allocated an address from a pool of addresses reserved by each DHCP server. A broadcast is used because the client does not know the address(es) of any DHCP server(s) on the network or sub-net.

In response to a DHCP discovery message, each listening DHCP server will broadcast a DHCP address offer that includes an IP address offered by the server to be assigned to the client that issued the DHCP discovery message. The IP address is allocated from among a set or sets of addresses reserved from each DHCP server. The DHCP address offers also include information identifying the DHCP server that sent the offer. Accordingly, as each DHCP server broadcasts its DHCP address offer, information identifying the server is stored in cache 105 in a block 306. Thus, the stored information is akin to a contact list that identifies the DHCP servers on the network or sub-net.

In further regard to the DHCP framework, DHCP clients are assigned an offered address via a “handshake” with the DHCP server making the offer. This is accomplished in a block 308 by having the client broadcast a DHCP request message indicating the client would like an offered address to be assigned to it. In response, the DHCP server that offered the address acknowledges the request to assign the address to the client. Since the request and acknowledgement are also broadcasts, all listening DHCP servers will be apprised of the newly assigned address for the client.

At this point, the client has an address and is aware of the addresses for each of the DHCP servers that responded to the initial DHCP discovery message. Accordingly, the client next attempts to find out what boot options are available via the DHCP servers. This is performed in accordance with a looping sequence delineated by start and end loop blocks 310 and 312. The operations pertaining to blocks 314 and 316 inside of the loop are thus performed for each DHCP server that broadcasts a DHCP address offer.

In block 314, the client requests boot options that are supported by the server. In one embodiment the client will send a message to each server that includes platform configuration information. In an alternative embodiment, such information is stored by each server, or stored on at least one server and made accessible to other servers. The reason for the platform configuration information is that bootable images such as OS images are generally particular to a specific platform configuration. As such, it would be of no advantage to receive boot options from a given server that are incompatible with the requesting client's platform configuration.

In response to the boot option request, in one embodiment each server will selectively return one or more boot options offered appropriate for the requesting client. In some instances, a server may support several bootable images compatible with a client's platform configuration. However, due to security or other reasons, the server will offer only a subset of those options. In other embodiments the servers may return boot options offered corresponding to all of the bootable images supported by the server and compatible with the client's platform configuration.

As boot option offers are received from the servers, unique offers are added to a list that is stored in cache 105, as depicted in block 316. The unique offer list comprises an aggregation of all of the unique boot options offered by the servers on the network or sub-net. In addition to identifying an offer, in one embodiment the server also sends additional content that assists the client in loading a bootable image once a boot option is selected. For example, the server may send respective bootable image loaders along with information pertaining to each boot option offer.

After boot options have been requested from each server, the logic proceeds to a decision block 318 in which a determination is made to whether any viable boot options offers were received. For example, in some instances they might not be any servers within listening range that support boot options that are compatible with a requesting client's platform configuration. If such is the case, there is no means for the client to boot from a network-stored bootable image, requiring the client to boot from a locally stored image, or to not boot at all. In one embodiment in accordance with a block 320, the client performs a default boot corresponding to non-availability of a network boot option. Additionally, a message may also be displayed on the client (or logged internally) to inform a user or administrator that no boot option offers were received. In instances in which the client is a diskless system, the client may be prevented from booting altogether.

If one or more viable boot options are received by the client, the pre-boot initialization continues in accordance with a block 322. This process will lead to a user-initiated or automatic selection of a boot option that corresponds to a bootable image. The bootable image will be loaded from the network to the client.

As will be appreciated, the foregoing scheme may be implemented without making any changes to the server side components. In an optional scheme, the boot servers are programmed to be aware that there may be more than one boot server, and coordinate presentation of boot offers to requesting clients. For example, in one embodiment the client would negotiate a network address with one server and then ask that server for boot options available across the network. The server would then acquire boot option offers from other servers, and present an aggregation of the boot option offers back to the client.

FIG. 4 illustrates an embodiment of an exemplary computer system 400 for practicing an embodiment of the invention described above. Computer system 400 is generally illustrative of various types of computer devices, including personal computers, laptop computers, workstations, servers, etc; for simplicity, only the basic components of the computer system are discussed herein. Computer system 400 includes a processor chassis 402 in which various hardware components are housed, including a floppy disk drive 404, a hard disk 406, a power supply (not shown), and a motherboard 408 populated with appropriate integrated circuits including system memory 410 coupled to one or more processors 412. System memory 410 may include, but not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 412 may be a conventional microprocessor including, but not limited to, an Intel Corporation x86, Pentium, or Itanium family microprocessor, a Motorola family microprocessor, or the like. Hard disk 406 may comprise a single unit, or multiple units, and may optionally reside outside of computer system 400. The system also includes a boot firmware device on which firmware is stored, which may typically comprise non-volatile memory such as a ROM device 420 or a flash device 422. The motherboard may include other firmware devices as well (not shown). In general, the system's processors will comprise 32- or 64-bit architectures, and the system memory will include physical addressing schemes appropriate to the processor(s), and may be accessed via corresponding address and data buses to which the processor(s) and the memory are connected.

A monitor 414 is included for displaying graphics and text generated by firmware, software programs and program modules that are run by computer system 400, such as system information presented during system boot. A mouse 416 (or other pointing device) may be connected to a serial port, USB port, or other like bus port communicatively coupled to CPU(s) 412. A keyboard 418 is communicatively coupled to motherboard 408 in a similar manner as mouse 416 for user entry of text and commands. In one embodiment, computer system 400 also includes a network interface card NIC or built-in NIC interface (not shown) for connecting computer system 400 to a computer network 430, such as a local area network (LAN), wide area network (WAN), or the Internet. In one embodiment network 430 is further coupled to a remote computer 435, such that computer system 400 and remote computer 435 can communicate. In one embodiment, a portion of the system's firmware is loaded during system boot from remote computer 435. In one embodiment of the present invention, a boot option residing on remote computer 435 (e.g., a server) is loaded onto computer system 400.

The illustrated embodiment further includes an optional add-in card 424 that is coupled to an expansion slot of motherboard 408. In one embodiment, add-in card 424 includes an Option ROM 426 on which firmware is stored. Computer system 400 may also optionally include a compact disk-read only memory (“CD-ROM”) drive 428 into which a CD-ROM disk may be inserted so that executable files, such as an operating system, and data on the disk can be read or transferred into system RAM 410 and/or hard disk 406. Other mass memory storage devices may be included in computer system 400.

In another embodiment, computer system 400 is a handheld or palmtop computer, which are sometimes referred to as personal digital assistants (PDAs). Handheld computers may not include a hard disk or other mass storage, and the executable programs are loaded from a corded or wireless network connection into memory 410 for execution by processor 412. A typical computer system 400 will usually include at least a processor 412, memory 410, and a bus (not shown) coupling the memory 410 to the processor 412.

Thus, embodiments of this invention may be used as or to support a firmware and software code executed upon some form of processing core (such as processor 412) or otherwise implemented or realized upon or within a machine-readable medium. A machine-readable medium includes any mechanism for storing or transmitting information in a form readable by a machine (e.g., a computer). For example, a machine-readable medium can include, but not limited to, a read only memory (ROM), a random access memory (RAM), a magnetic disk storage media, an optical storage media, a flash memory device, and the like. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
issuing a request from a client over a network to a plurality of servers for said servers to respond with any boot options they support;
receiving at the client, a plurality of boot option offers from at least two of said plurality of servers, each boot option offer identifying boot options offered by a corresponding server;
selecting a boot option from said plurality of boot option offers; and
retrieving a bootable image corresponding to the boot option that was selected.

2. The method of claim 1, wherein the request is issued as a network broadcast.

3. The method of claim 2, further comprising broadcasting the request repeatedly until boot option offers are received from any servers listening to the broadcast that provide support for corresponding boot options.

4. The method of claim 1, wherein receiving at the client a plurality of boot option offers comprises:
receiving DHCP (Dynamic Host Control Protocol) address offers from servers responding to the request from the client, wherein the request is a DHCP discover broadcast;
storing at the client a list of the servers the client received DHCP address offers from;
broadcasting by the client a DHCP request message, the DHCP request message to indicate to a first server of the plurality of servers that the client to accept the first server's DHCP address offer;
receiving from the first server a DHCP acknowledgement including an assigned client address;
requesting boot option offers from each responding server via the assigned client address; and
storing the boot option offers received from each responding server.

5. The method of claim 1, wherein the boot options offered by at least one of the plurality of servers is different than the boot options offered by any other of the plurality of servers.

6. The method of claim 1, further comprising:
presenting a list of boot options to a user of the client, said list comprising an aggregation of the boot option offers received by the client; and
enabling the user to select a boot option from the list, said bootable image that is retrieved corresponding to the boot option selected by the user.

7. The method of claim 1, further comprising:
building a list of boot options comprising an aggregation of the boot option offers received by the client; and
automatically selecting a boot option from the list, said bootable image that is retrieved corresponding to the boot option that is automatically selected.

8. The method of claim 1, wherein receiving a boot option offer from a server comprises:
completing a handshake with the server; and
receiving data regarding one or more boot options supported by the server.

9. The method of claim 1, wherein retrieving the bootable image comprises:
receiving a boot loader at the client; and
executing the boot loader to initiate retrieval of the bootable image over the network.

10. The method of claim 1, wherein the bootable image is stored on the server that responded with a boot option offer corresponding to the boot option that was selected.

11. The method of claim 1, wherein the bootable image is stored on a storage device connected to the network that is external from the server that responded with a boot option offer corresponding to the boot option that was selected.

12. The method of claim 11, wherein the bootable image is retrieved by retrieving the bootable image from the storage device via the server.

13. The method of claim 1, wherein the boot option offer made by at least one of said plurality of servers comprises one or more boot options that are specific to a platform configuration of the client.

14. A machine-readable media on which a plurality of instructions are stored, which when executed on a client perform operations comprising:
broadcasting at least one boot option request over a network;
receiving first and second boot option offers from respective first and second servers coupled to the network, each boot option offer identifying at least one boot option supported by the server from which it is received;
storing an aggregation of boot options offered from the first and second boot option offers;
facilitating selection of a boot option from the aggregation of boot options; and
retrieving a bootable image corresponding to the selected boot option.

15. The machine-readable media of claim 14, wherein said at least one boot option request comprises a first request that is responded to by the first server and a second request that is responded to by the second server.

16. The machine-readable media of claim 14, wherein the operations further comprise tracking from which servers boot option offers have been received to determine if boot option offers have been received from the first server and the second server.

17. The machine-readable media of claim 14, wherein at least one of the boot options supported by the first server is different than any of the boot options supported by the second server.

18. The machine-readable media of claim 14, wherein facilitating selection of the boot option comprises:
presenting a list of boot options to a user of the client comprising the aggregation of the boot option offers received by the client; and
enabling the user to select a boot option from the list, said bootable image that is retrieved corresponding to the boot option selected by the user.

19. The machine-readable media of claim 14, wherein facilitating selection of the boot option comprises automatically selecting a boot option from the aggregation of boot options.

20. The machine-readable media of claim 14, wherein the broadcast comprises a DHCP (Dynamic Host Control Protocol) broadcast, and the boot option offer from the first server includes a network address offered to the client.

21. The machine-readable media of claim 14, wherein the operations further comprise broadcasting an acceptance of the first boot option offer over the network.

22. The machine-readable media of claim 14, wherein retrieving the bootable image comprises:
receiving a boot loader at the client; and
executing the boot loader to initiate retrieval of the bootable image over the network.

23. A computer system, comprising:
a processor;
a memory operatively coupled to the processor;
a network interface operatively coupled to the processor; and
at least one firmware device operatively coupled to the processor on which firmware instructions are stored, which when executed by the processor perform operations comprising:
broadcasting a boot option request on a network via the network interface, the network having a plurality of servers;
receiving a plurality of boot option offers from at least two of said plurality of servers, each boot option offer identifying boot options offered by a corresponding server;
facilitating selection of a boot option from said plurality of boot option offers; and
retrieving a bootable image corresponding to the boot option that was selected.

24. The computer system of claim 23, wherein the firmware operates in accordance with the Extensible Firmware Interface (EFI) framework.

25. The computer system of claim 23, wherein facilitating selection of the boot option comprises:
presenting a list of boot options to a user of the computer system comprising an aggregation of the boot option offers received by the client; and
enabling the user to select a boot option from the list, said bootable image that is retrieved corresponding to the boot option selected by the user.

26. The computer system of claim 23, wherein facilitating selection of the boot option comprises automatically selecting a boot option from among the boot option offers received by the computer system.

27. The computer system of claim 23, wherein the broadcast comprises a DHCP (Dynamic Host Control Protocol) broadcast, and the boot option offer from at least one of the plurality of servers includes a network address offered to the client.

28. A method, comprising:
receiving at a server a boot option request from a client, the server and the client coupled to a network;
sending by the server a boot option offer to the client, the boot option offer identifying at least one boot option supported by the server;
receiving at the server a request from the client to select one of the at least one boot option; and
sending by the server a bootable image to the client corresponding to the boot option that was selected.

29. The method of claim 28, wherein sending by the server a boot option offer includes:
completing a handshake with the client; and
sending data regarding one or more boot options supported by the server.

30. The method of claim 28, wherein sending by the server a boot option offer is conducted according to the Dynamic Host Control Protocol (DHCP).
